(19) United States
(12) Patent Application Publication
(10) Pub. No.: US 2002/0090481 A1
(43) Pub. Date: Jul. 11, 2002

(54) Filter-lift handle

(76) Inventor: Bernard Martin Knowlton, Santa Barbara, CA (US)

Correspondence Address: BERNARD M. KNOWLTON, P.O. Box 6464, SANTA BARBARA, CA, 93160, US

(21) Appl. No.: 09/966,539

(22) Filed: Sep. 27, 2001

Related U.S. Application Data
(60) Provisional application No. 60/236,184, filed on Sep. 29, 2000.

(51) Int. Cl. B32B 3/28

(52) U.S. Cl. 428/40.1; 428/174

(57) ABSTRACT

This invention facilitates the pickup and/or retrieval of objects which are small and difficult to secure a hold with the ordinary finger grasp. To name a few are pins, needles, thread ends, stamps, contact lenses, small coins, razor blades. This invention will turn pages in books, magazines, Bibles in particular, due to their fine, thin type of paper. This invention is a small, inexpensive inovation which will be easy to manufacture since it is only one small piece of material formed into an L shape. Plastic, heavy paper, cardboard, or thin metal can be used. It is fitted with a heavy duty double-sided foam sticky layer on the bottom section as the adhering matter to pick up the object. This invention will be especially helpful to people suffering from arthritis or other similar afflictions in their hands.

The main usage will be the removal of coffee filters from the manufacturer's shipping container. The coffee filter is usually packed in multiples of 25 to 200 of closely packed filters in either a box container or a loose cellophane wrapper-type container. The filters are stacked inside each other in a close, firm manner resulting in a very difficult removal of a single filter, however, with this invention a single filter can easily be removed.

### CROSS-REFERENCE TO RELATED APPLICATIONS

Application No. 60/236,184, Filing Date Sep. 29, 2000. Copy attached

### STATEMENT REGARDING FEDERALLY SPONSORED RESEARCH OF DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of the present invention relates to a device for picking up objects which are difficult to grasp due to their smallness or in those cases where paper products or pages present difficulty due to their smallness or paper objects where they adhere together such as pages in a book or filters for coffee machine. This condition is especially true when persons with problems such as artthritis. With this invention it is possible to pickup needles, straight pins, razor blades, nail files, turn pages in a book, expecially in the Bible when such books have very thin pages and are really difficult to turn over. It is very handy and safe to pick up contact glasses in most situations.

The inventor has no knowledge of a similar device that fulfill so many pick-up jobs and yet is small enough to fit into ladies purse.

### SUMMARY OF THE INVENTION

The present invention is a simple device made from plastic, heavy paper, cardboard, light metal with the front portion angled to a position that applies pressure over the center of the device which permits a spring-like action so that the weight is distributed evenly. The manufacture will be very simple and easy since the L shape is readily available in plastic and would only involve the angle shaping and cutting the L shape material into the desireable lengths.

### BRIEF DESCRIPTION OF THE DRAWINGS

FIG. 1 is an end view of the invention illustrating the relationship between the bottom side and the angled front side which side is grasped by the fingers for operation.

FIG. 2 is a front view of the invention.

FIG. 3 is a bottom view of the invention.

FIG. 4 is a perspective view of the invention demonstrating the angled position of the front side to the bottom side.

FIG. 5 is a perspective rendering of the invention displaying the adhesive attached to the bottom.

FIG. 6 is a perspective drawing of what the invention might appear in its final form.

### DETAILED DESCRIPTION OF THE EMBODIMENTS

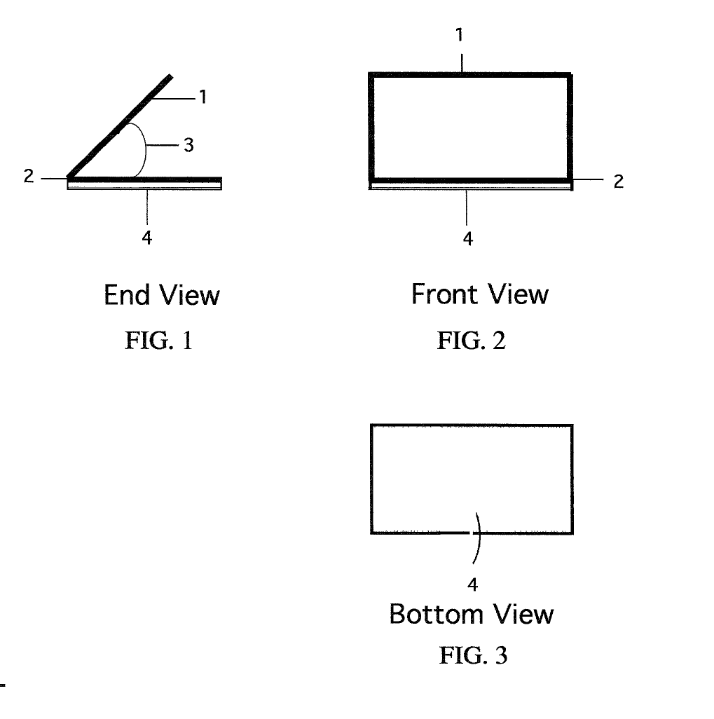

FIG. 1 shows the angled front side 1 in its angled relationship to the bottom side 2 with the angle indicated as 3. The heavy duty double-stick foam layer 4 serves as the material to pick up items.

FIG. 2 shows the relationship of 1, 2, 4 in a front view.

FIG. 3 illustrates that the bottom side 2 is completely covered by the heavy duty double-stick foam layer 4.

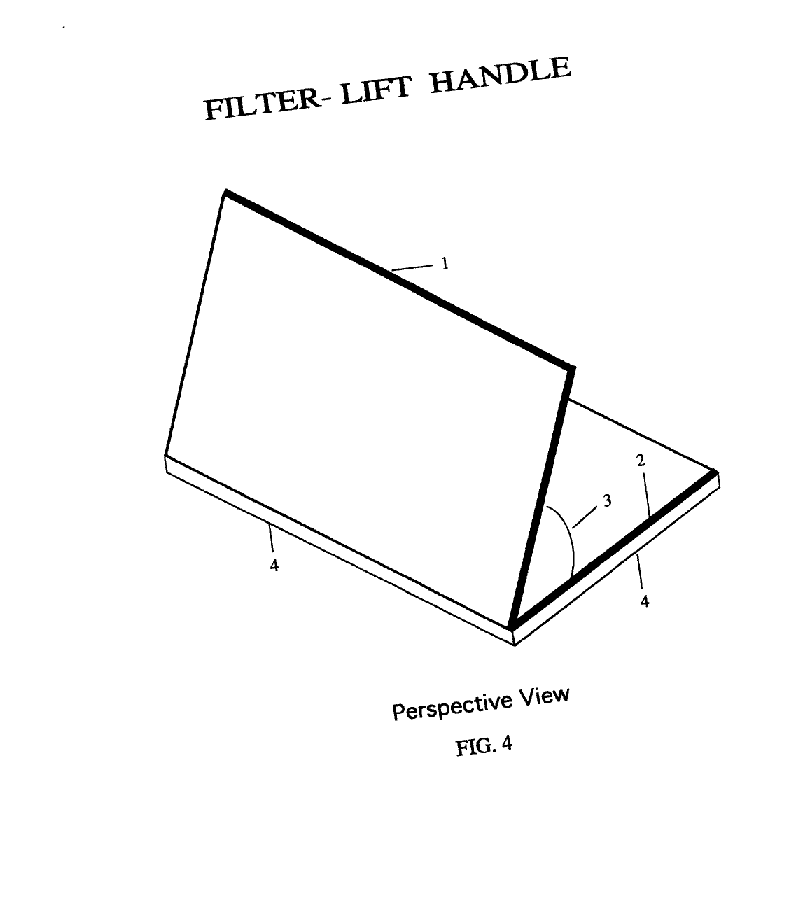

FIG. 4 demonstrates all facets of the invention; front side 1, bottom side 2, angle 3 between 1 and 2, and the heavy duty double-stick foam layer 4.

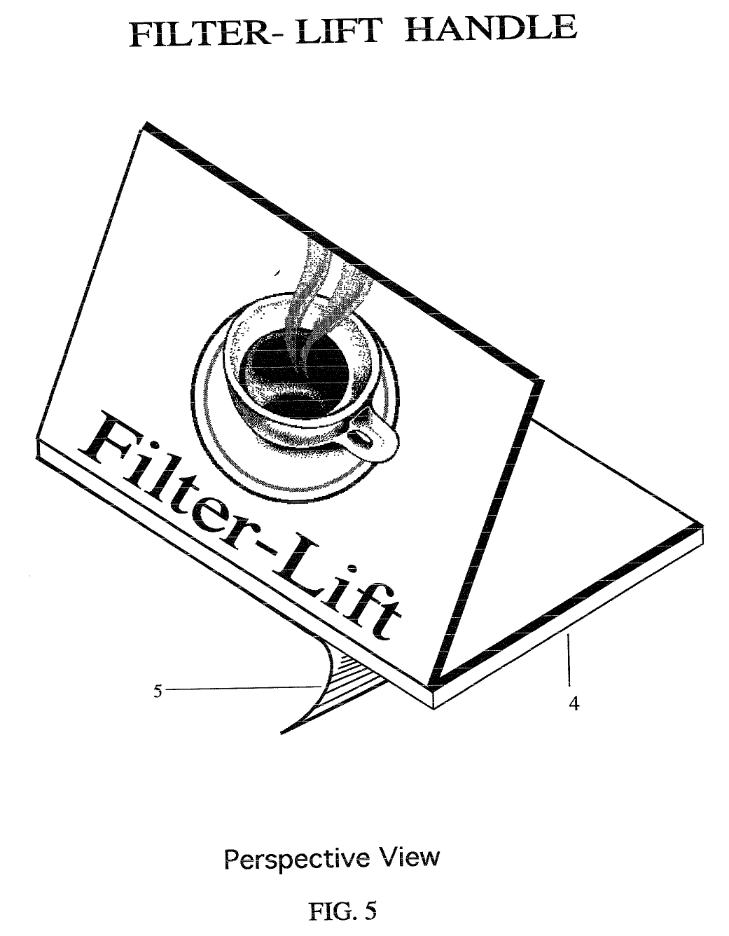

FIG. 5 demonstrates how the protective cover 5 over foam layer 4 must be peeled off prior to use.

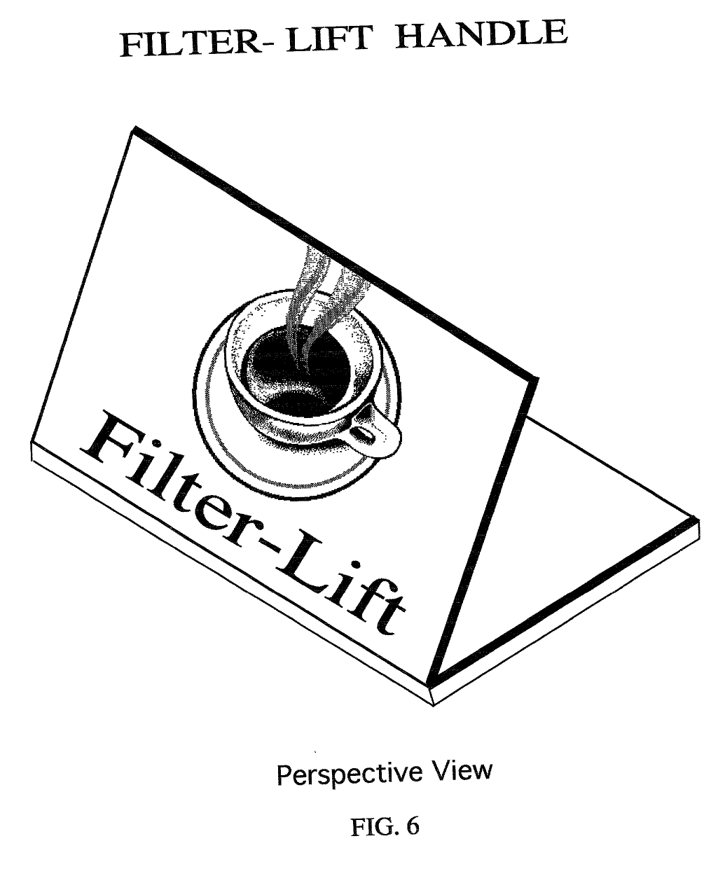

FIG. 6 illustrates how the invention might appear in one of its commercial applications.

### DETAILED DESCRIPTION OF THE INVENTION

This invention overcomes the difficulty of removing the coffee filter from its shipping container. The coffee filters are usually packed by the manufacturer in either a cardboard box container or a loose cellophane or plastic container. The filters are sold stacked inside each other in a close, firm manner resulting in a very difficult and frustrating effort to remove one without disturbing the remaining stack. In many cases, in attempting to remove one filter, several will come out together. This invention will be included in each of the manufacturer's container.

The invention consists of a single object made from plastic, heavy paper, cardboard or thin metal. It is formed in the shape of an L with the upright side 1 at an angle 3 of approximately 50 degrees to the bottom side 2. The bottom side 2 is covered by a double-stick foam layer 4. For the first time usage, the protective cover 5 is removed from the foam layer 4 and discarded, thereafter the invention is stored in with the filters and is ready for instant use.

1. What I claim as my invention is a device that assists persons in picking up small items although the best possible use of it would be lifting coffee filters from their container.
